(19) United States
(12) Patent Application Publication
(10) Pub. No.: US 2012/0050588 A1
(43) Pub. Date: Mar. 1, 2012

(54) IMAGE SENSING DEVICE

(75) Inventors: Hung-Miao Lo, Hsinchu County (TW); Min-Hui Hung, Hsinchu City (TW)

(73) Assignee: NOVATEK MICROELECTRONICS CORP., Hsinchu, (TW)

(21) Appl. No.: 13/092,993

(22) Filed: Apr. 25, 2011

(30) Foreign Application Priority Data
Aug. 31, 2010 (TW) 99129265

(51) Int. Cl. H04N 9/07

(52) U.S. Cl. 348/266

(57) ABSTRACT

An image sensing device including a light sensing plane and a shifting module is provided. A plurality of pixel blocks is disposed on the light sensing plane as an array. Each of the pixel blocks generates a first elementary color signal, a second elementary color signal, a third elementary color signal, and a fourth elementary color signal according to an illumination intensity. The shifting module has a first output terminal and a second output terminal. The shifting module receives the first elementary color signals, the second elementary color signals, the third elementary color signals, and the fourth elementary color signals, and outputs one of the third elementary color signals and one of the fourth elementary color signals at the second output terminal. Each of the third elementary color signals and each of the fourth elementary color signals are two signals corresponding to the same color light.

### CROSS-REFERENCE TO RELATED APPLICATION

This application claims the priority benefit of Taiwan application serial no. 99129265, filed Aug. 31, 2010. The entirety of the above-mentioned patent application is hereby incorporated by reference herein and made a part of this specification.

### BACKGROUND OF THE INVENTION

1. Field of the Invention

The invention generally relates to a photosensitive device, and more particularly, to an image sensing device.

2. Description of Related Art

Digital cameras, digital monitors, and digital video cameras have been broadly used in our daily life along with the development of semiconductor and photovoltaic technologies. A photosensitive device is usually disposed in a digital camera, a digital monitor, or a digital video camera for converting an optical signal into an electrical signal and outputting the electrical signal for back-end image processing.

Generally speaking, photosensitive devices are charge coupled devices (CCDs). Because the conventional single-channel CCD offers a low transmission speed therefore cannot meet the requirement of today's market, a dual-channel CCD having a transmission speed twice of that of the single-channel CCD is provided. However, serious noises may be produced in images if there is any process mismatch in the back-end circuit.

### SUMMARY OF THE INVENTION

Accordingly, the invention is directed to an image sensing device that can reduce image noise caused by process mismatch in back-end circuit.

The invention provides an image sensing device including a light sensing plane and a shifting module. A plurality of pixel blocks is disposed on the light sensing plane as an array. Each of the pixel blocks generates a first elementary color signal, a second elementary color signal, a third elementary color signal, and a fourth elementary color signal according to an illumination intensity. The shifting module has a first output terminal and a second output terminal. The shifting module receives the first elementary color signals, the second elementary color signals, the third elementary color signals, and the fourth elementary color signals and outputs one of the third elementary color signals and one of the fourth elementary color signals at the second output terminal. Each of the third elementary color signals and each of the fourth elementary color signals are two signals corresponding to the same color light.

According to an embodiment of the invention, the shifting module further outputs one of the first elementary color signals and one of the second elementary color signals at the first output terminal.

According to an embodiment of the invention, each of the pixel blocks includes a first pixel sensing unit, a second pixel sensing unit, a third pixel sensing unit, and a fourth pixel sensing unit for respectively generating the corresponding first elementary color signal, the corresponding second elementary color signal, the corresponding third elementary color signal, and the corresponding fourth elementary color signal.

According to an embodiment of the invention, the first pixel sensing units and the third pixel sensing units are alternatively disposed in a (2i−1)^{th} row of the light sensing plane, and the second pixel sensing units and the fourth pixel sensing units are alternatively disposed in a (2i)^{th} row of the light sensing plane, wherein the third pixel sensing units in the (2i−1)^{th} row and the fourth pixel sensing units in the (2i)^{th} row are disposed in different columns, 1≦2i≦2N, and i and N are positive integers greater than or equal to 1.

According to an embodiment of the invention, the shifting module includes a plurality of shift registers and a switch unit. The shift registers respectively and correspondingly receive the first elementary color signals and the third elementary color signals in the (2i−1)^{th} row. The shift registers are connected in series and sequentially shift the first elementary color signals and the third elementary color signals to output one of the first elementary color signals and one of the third elementary color signals. The switch unit is coupled to the shift registers. The switch unit receives the corresponding first elementary color signal and the corresponding third elementary color signal and outputs the received first elementary color signal and the received third elementary color signal respectively at the first output terminal and the second output terminal of the shifting module.

According to an embodiment of the invention, the shift registers further respectively and correspondingly receive the fourth elementary color signals and the second elementary color signals in the (2i)^{th} row. The shift registers sequentially shift the fourth elementary color signals and the second elementary color signals and output one of the fourth elementary color signals and one of the second elementary color signals. The switch unit receives the corresponding fourth elementary color signal and the corresponding second elementary color signal and outputs the received second elementary color signal and the received fourth elementary color signal respectively at the first output terminal and the second output terminal of the shifting module.

According to an embodiment of the invention, the shifting module includes a plurality of switch units and a plurality of shift registers. Each of the switch units has a first input terminal, a second input terminal, a third output terminal, and a fourth output terminal. The first input terminals receive the first elementary color signals in the (2i−1)^{th} row and output the first elementary color signals at the third output terminals. The second input terminals receive the third elementary color signals in the (2i−1)^{th} row and output the third elementary color signals at the fourth output terminals. Each of the shift registers is correspondingly coupled to one of the third output terminals or one of the fourth output terminals. The shift registers are connected in series and sequentially shift the first elementary color signals and the third elementary color signals to output one of the first elementary color signals and one of the third elementary color signals respectively at the first output terminal and the second output terminal of the shifting module.

According to an embodiment of the invention, the first input terminals further receive the fourth elementary color signals in the (2i)^{th} row and output the fourth elementary color signals at the fourth output terminals. The second input terminals further receive the second elementary color signals in the (2i)^{th} row and output the second elementary color signals at the third output terminals. The shift registers sequentially shift the second elementary color signals and the fourth elementary color signals to output one of the second elementary color signals and one of the fourth elementary color signals respectively at the first output terminal and the second output terminal of the shifting module.

According to an embodiment of the invention, the shifting module includes a first shifting unit and a second shifting unit. The first shifting unit includes a plurality of first shift registers. The first shifting unit respectively and correspondingly receives the first elementary color signals and the third elementary color signals in the (2i−1)^{th} row, wherein the first shift registers are connected in series and sequentially shift the first elementary color signals and the third elementary color signals. The second shifting unit is coupled to the first shifting unit. The second shifting unit receives one of the first elementary color signals or one of the third elementary color signals and outputs the received first elementary color signal and the received third elementary color signal respectively at the first output terminal and the second output terminal of the shifting module according to a control signal.

According to an embodiment of the invention, the first shift registers further respectively and correspondingly receive the fourth elementary color signals and the second elementary color signals in the (2i)^{th} row and sequentially shift the fourth elementary color signals and the second elementary color signals. Besides, the second shifting unit further receives one of the fourth elementary color signals or one of the second elementary color signals and outputs the received fourth elementary color signal at the second output terminal of the shifting module or outputs the received second elementary color signal and the received fourth elementary color signal respectively at the first output terminal and the second output terminal of the shifting module according to the control signal.

According to an embodiment of the invention, the second shifting unit includes two second shift registers that are connected in series. The second shift registers respectively outputs the first elementary color signal and the third elementary color signal according to the control signal at a first time.

According to an embodiment of the invention, the second shifting unit resets one of the second shift registers and outputs the fourth elementary color signal at the second output terminal according to the control signal at a second time, and the second shifting unit outputs the fourth elementary color signal and the second elementary color signal respectively at the first output terminal and the second output terminal of the shifting module at a third time.

According to an embodiment of the invention, the second shifting unit outputs the fourth elementary color signal at the third time through another one of the second shift registers.

According to an embodiment of the invention, the second pixel sensing units in the (2i)^{th} row are respectively coupled to the first pixel sensing units in the (2i−1)^{th} row and the first pixel sensing units in a (2i+1)^{th} row and form a plurality of first sensing strings.

According to an embodiment of the invention, the first pixel sensing units coupled to the first pixel sensing units in the (2i)^{th} row are in a same column.

According to an embodiment of the invention, the fourth pixel sensing units in the (2i)^{th} row are respectively coupled to the third pixel sensing units in the (2i−1)^{th} row and the third pixel sensing units in the (2i+1)^{th} row and form a plurality of second sensing strings.

According to an embodiment of the invention, the third pixel sensing units coupled to the fourth pixel sensing units in the (2i)^{th} row are in a same column.

According to an embodiment of the invention, the shifting module includes a plurality of first shift registers and a plurality of second shift registers. The first shift registers are respectively coupled to the first sensing strings for receiving one of the first elementary color signals. The second shift registers are respectively coupled to the second sensing strings for receiving one of the third elementary color signals. The first shift registers and the second shift registers are alternatively connected in series and sequentially shift the first elementary color signals and the third elementary color signals so that the shifting module outputs one of the first elementary color signals and one of the third elementary color signals respectively at the first output terminal and the second output terminal.

According to an embodiment of the invention, the first shift registers further receive one of the second elementary color signals, and the second shift registers further receive one of the fourth elementary color signals. The first shift registers and the second shift registers sequentially shift the second elementary color signals and the fourth elementary color signals so that the shifting module outputs one of the second elementary color signals and one of the fourth elementary color signals respectively at the first output terminal and the second output terminal.

According to an embodiment of the invention, each of the first elementary color signals and each of the second elementary color signals are two signals corresponding to different color lights.

As described above, in an embodiment of the invention, two signals corresponding to the same color light are output through the same output terminal by adopting a shifting module, so that image noise caused by gain mismatch can be eliminated in back-end circuit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an image sensing device according to a first embodiment of the invention.

FIG. 2 is a diagram of an image sensing device according to a second embodiment of the invention.

FIG. 3 is a diagram of an image sensing device according to a third embodiment of the invention.

FIG. 4A is a diagram of an image sensing device according to a fourth embodiment of the invention.

FIG. 4B is a simplified circuit diagram of the image sensing device in FIG. 4A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Following embodiments will be described by taking a charge coupled device (CCD) as an example. However, those having ordinary knowledge in the art should understand that the image sensing device provided by the invention is not limited to a CCD, and any electronic device that can convert an optical signal into an electrical signal is within the scope of the invention.

### First Embodiment

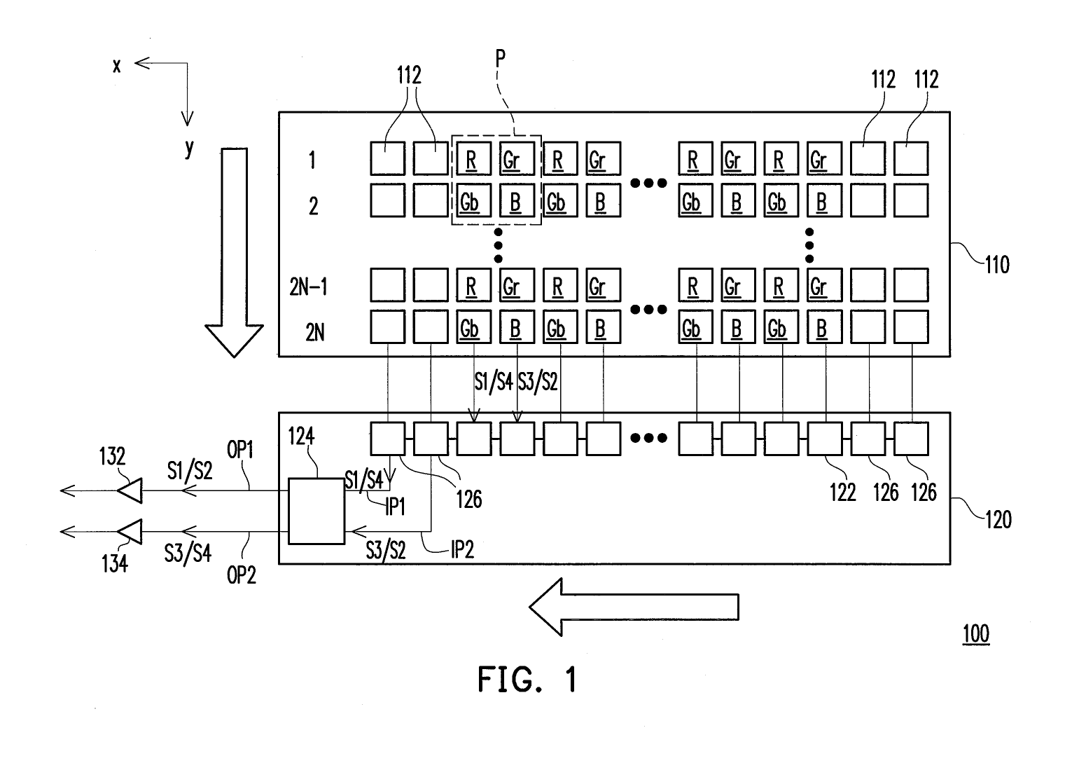

FIG. 1 is a diagram of an image sensing device 100 according to the first embodiment of the invention. Referring to FIG. 1, the image sensing device 100 includes a light sensing plane 110 and a shifting module 120. The image sensing device 100 may be a CCD. A plurality of pixel blocks P is disposed on the light sensing plane 110 as an array, and each of the pixel blocks P generates an elementary color signal S1, an elementary color signal S2, an elementary color signal S3, and an elementary color signal S4 according to an illumination intensity.

The shifting module 120 has an output terminal OP1 and an output terminal OP2. The shifting module 120 receives the elementary color signals S1, S2, S3, and S4 and outputs one of the elementary color signals S3 and one of the elementary color signals S4 at the output terminal OP2, wherein the elementary color signal S3 and the elementary color signal S4 are two signals corresponding to the same color light. For example, the elementary color signal S3 and the elementary color signal S4 may be two signals corresponding to a green light. On the other hand, the shifting module 120 further outputs one of the elementary color signals S1 and one of the elementary color signals S2 at the output terminal OP1, wherein the elementary color signal S1 and the elementary color signal S2 may be two signals corresponding to different color lights. For example, the elementary color signal S1 may be a signal corresponding to a red light, and the elementary color signal S2 may be a signal corresponding to a blue light. It should be noted that the invention is not limited thereto, and in another embodiment, the elementary color signal S1 and the elementary color signal S2 may also respectively be a signal corresponding to a blue light and a signal corresponding to a red light.

To be specific, each pixel block P includes a pixel sensing unit R, a pixel sensing unit B, a pixel sensing unit Gr, and a pixel sensing unit Gb for respectively generating the corresponding elementary color signal S1, elementary color signal S2, elementary color signal S3, and elementary color signal S4. Furthermore, the pixel sensing unit R generates a elementary color signal S1 corresponding to a red light, the pixel sensing unit B generates a elementary color signal S2 corresponding to a blue light, and the pixel sensing unit Gr and the pixel sensing unit Gb generate elementary color signals S3 and S4 corresponding to a green light. Generally speaking, because human eyes are most sensitive to green light, two pixel sensing units Gr and Gb corresponding to the green light are disposed in each pixel block P of the light sensing plane 110, wherein the two pixel sensing units Gr and Gb are diagonally disposed and respectively generate the elementary color signals S3 and S4 corresponding to the green light.

As shown in FIG. 1, in the present embodiment, the pixel sensing units R and the pixel sensing units Gr are alternatively disposed in the (2i−1)^{th} row of the light sensing plane 110, and the pixel sensing units B and the pixel sensing units Gb are alternatively disposed in the (2i)^{th} row of the light sensing plane 110, wherein the pixel sensing units Gr in the (2i−1)^{th} row and the pixel sensing units Gb in the (2i)^{th} row are located in different columns, 1≦2i≦2N, and i and N are positive integers greater than or equal to 1. For example, when N=4, the pixel sensing units R and the pixel sensing units Gr are alternatively disposed in the odd number (1^{st}, 3^{rd}, 5^{th}, and 7^{th}) of rows of the light sensing plane 110, and the pixel sensing units B and the pixel sensing units Gb are alternatively disposed in the even number (2^{nd}, 4^{th}, 6^{th}, and 8^{th}) of rows of the light sensing plane 110. In other words, the pixel sensing units R and Gr and the pixel sensing units B and Gb in the pixel blocks P are located in every two adjoining rows.

On the other hand, in the present embodiment, the shifting module 120 includes a plurality of shift registers 122 and a switch unit 124. The switch unit 124 is coupled to the shift registers 122, and which may be a switch circuit. The shift registers 122 respectively receive the elementary color signals S1 and the elementary color signals S3 in the (2i−1)^{th} row (for example, the 1^{st}, 3^{rd}, 5^{th}, . . . , or (2N-1)^{th} row). The shift registers 122 are connected in series and sequentially shift the elementary color signals S1 and the elementary color signals S3 to output one of the elementary color signals S1 and one of the elementary color signals S3.

To be specific, the elementary color signals S1 generated by the pixel sensing units R in the (2i−1)^{th} row and the elementary color signals S3 generated by the pixel sensing units Gr in the (2i−1)^{th} row are sequentially transmitted to the shifting module 120 in the direction y and are stored in the shift registers 122. Then, the shift registers 122 sequentially shift the elementary color signals S1 and the elementary color signals S3 in the direction x to output the elementary color signals S1 and the elementary color signals S3 to the switch unit 124. The switch unit 124 receives the corresponding elementary color signal S1 and the corresponding elementary color signal S3 and outputs the received elementary color signal S1 and the received elementary color signal S3 respectively at the output terminal OP1 and the output terminal OP2 of the shifting module 120.

Additionally, the shift registers 122 further respectively receive the elementary color signals S4 and the elementary color signals S2 in the (2i)^{th} row (for example, the 2^{nd}, 4^{th}, 6^{th}, . . . , or 2N^{th} row). The shift registers 122 sequentially shift the elementary color signals S4 and the elementary color signals S2 and output one of the elementary color signals S4 and one of the elementary color signals S2. Then, the switch unit 124 receives the corresponding elementary color signal S4 and the corresponding elementary color signal S2 and outputs the received elementary color signal S2 and elementary color signal S4 respectively at the output terminal OP1 and the output terminal OP2 of the shifting module 120.

Similarly, the elementary color signals S4 generated by the pixel sensing units Gb in the (2i)^{th} row and the elementary color signals S2 generated by the pixel sensing units B in the (2i)^{th} row are sequentially transmitted to the shifting module 120 in the direction y and are stored in the shift registers 122. Then, the shift registers 122 sequentially shift the elementary color signals S4 and the elementary color signals S2 in the direction x to output the elementary color signals S4 and the elementary color signals S2 to the switch unit 124. After that, the switch unit 124 receives the corresponding elementary color signal S4 and the corresponding elementary color signal S2 and outputs the received elementary color signal S2 and elementary color signal S4 respectively at the output terminal OP1 and the output terminal OP2 of the shifting module 120.

Moreover, in the present embodiment, a plurality of virtual pixel sensing units 112 is further disposed on the light sensing plane 110, wherein the virtual pixel sensing units 112 are disposed at both sides of the light sensing plane 110, and the pixel blocks P are located between the virtual pixel sensing units 112. On the other hand, in the present embodiment, the shifting module 120 further includes a plurality of shift registers 126, wherein the shift registers 126 are coupled between the virtual pixel sensing units 112 and the switch unit 124 and are connected with the shift registers 122 in series.

Additionally, as shown in FIG. 1, in the present embodiment, the output terminals OP1 and OP2 are respectively coupled to the output buffers 132 and 134, wherein the output buffers 132 and 134 are used for driving back-end circuit. Generally speaking, the problem of gain mismatch may be produced between the output buffers 132 and 134 due to the affection of the process. Thus, if the elementary color signals S3 and S4 corresponding to the same color light are output to the output buffers 132 and 134 through different output terminals OP1 and OP2, series noises may be produced in images due to gain mismatch between the output buffers 132 and 134.

In order to resolve foregoing problem of gain mismatch and the production of noises in an image, in the present embodiment, the elementary color signals S3 and S4 corresponding to the same color light are transmitted to the same output buffer (for example, the output buffer 134) through the same output terminal OP2 by using the switch unit 124.

For example, when an elementary color signal S1 and an elementary color signal S3 are transmitted to the input terminals IP1 and IP2 of the switch unit 124 through the virtual pixel sensing units 112, the switch unit 124 transmits the elementary color signal S1 from the input terminal IP1 to the output terminal OP1 and transmits the elementary color signal S3 from the input terminal IP2 to the output terminal OP2.

On the other hand, when an elementary color signal S4 and an elementary color signal S2 are transmitted to the input terminals IP1 and IP2 of the switch unit 124 through the virtual pixel sensing units 112, the switch unit 124 transmits the elementary color signal S4 from the input terminal IP1 to the output terminal OP2 and transmits the elementary color signal S2 from the input terminal IP2 to the output terminal OP1. Accordingly, the elementary color signal S3 and the elementary color signal S4 corresponding to the same color light are output through the same output terminal OP2, so that the problem of gain mismatch between back-end devices (for example, the output buffers 132 and 134) is prevented. It should be noted that in another embodiment, the elementary color signal S3 and the elementary color signal S4 corresponding to the same color light may also be output through the output terminal OP1, and the elementary color signals S1 and S2 may be output through the output terminal OP2.

According to another embodiment, the output terminals OP1 and OP2 are respectively coupled to an analog-to-digital converter (ADC) for carrying out analog-to-digital conversion. Generally speaking, when analog-to-digital conversions are performed, the signals output from the ADCs may also show some difference due to different characteristics of the ADCs. However, in the present embodiment, because the switch unit 124 outputs the elementary color signal S3 and the elementary color signal S4 corresponding to the same color light through the same output terminal (for example, the output terminal OP2), gain mismatch can be effectively avoided in back-end circuit.

### Second Embodiment

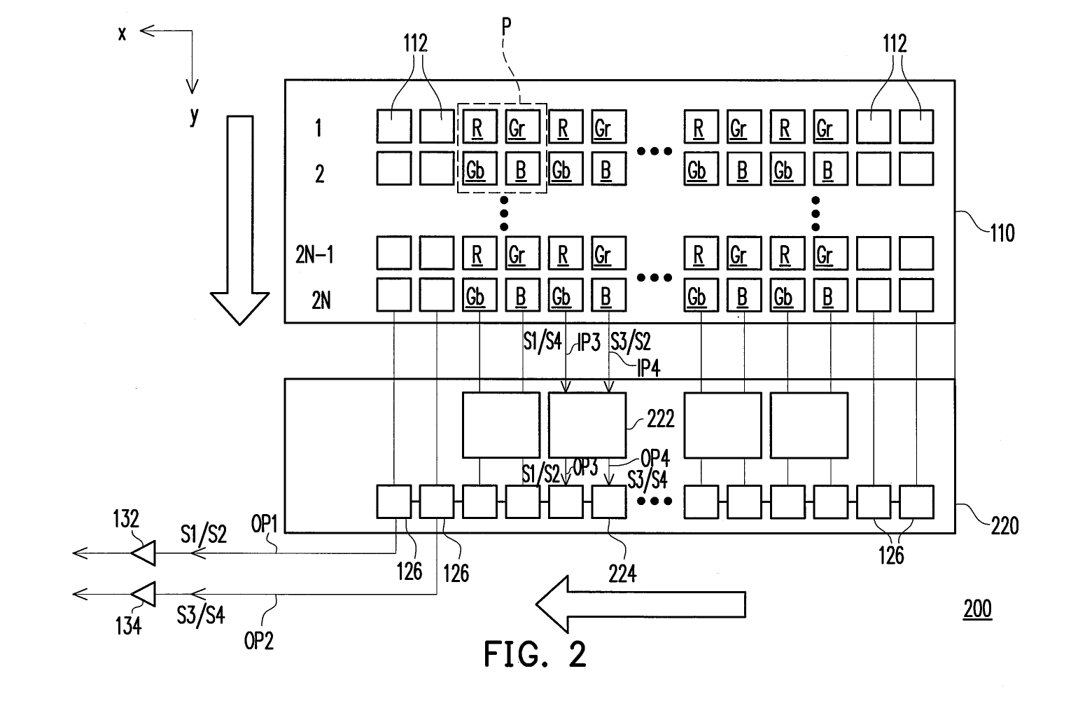

FIG. 2 is a diagram of an image sensing device 200 according to the second embodiment of the invention. The image sensing device 200 in the present embodiment is similar to the image sensing device 100 illustrated in FIG. 1. The difference between the two image sensing devices falls between the shifting module 220 and the shifting module 120 in FIG. 1.

Referring to FIG. 2, in the present embodiment, the shifting module 220 includes a plurality of switch units 222 and a plurality of shift registers 224. Each switch unit 222 has an input terminal IP3, an input terminal IP4, an output terminal OP3, and an output terminal OP4. The input terminals IP3 receive the elementary color signals S1 generated by the pixel sensing units R in the (2i−1)^{th} row and output the elementary color signals S1 at the output terminals OP3, and the input terminals IP4 receive the elementary color signals S3 generated by the pixel sensing units Gr in the (2i−1)^{th} row and output the elementary color signals S3 at the output terminals OP4.

On the other hand, the shift registers 224 are respectively coupled to the output terminals OP3 or the output terminals OP4. The shift registers 224 are connected in series and sequentially shift the elementary color signals S1 and the elementary color signals S3, so as to output one of the elementary color signals S1 and one of the elementary color signals S3 respectively at the output terminal OP1 and the output terminal OP2 of the shifting module 220.

In addition, the input terminals IP3 further receive the elementary color signals S4 generated by the pixel sensing units Gb in the (2i)^{th} row and output the elementary color signals S4 at the output terminals OP4, and the input terminals IP4 further receive the elementary color signals S2 generated by the pixel sensing units B in the (2i)^{th} row and output the elementary color signals S2 at the output terminals OP3. Then, the shift registers 224 sequentially shift the elementary color signals S2 and the elementary color signals S4 to output one of the elementary color signals S2 and one of the elementary color signals S4 respectively at the output terminal OP1 and the output terminal OP2 of the shifting module 220. In other words, in the present embodiment, the transmission directions of the elementary color signals S4 and S2 are first switched through the switch units 222 to change the output channels of the elementary color signals S4 and S2, and the elementary color signals S4 and S2 are then shifted through the shift registers 224.

As described above, in the present embodiment, by controlling the switch units 222, the elementary color signals S3 and the elementary color signals S4 corresponding to the same color light are transmitted to the same output buffer (for example, the output buffer 134) or other back-end circuit through the same output terminal OP2, so that image noises caused by gain mismatch can be effectively eliminated. It should be noted that the invention is not limited to that described above, and in another embodiment, the elementary color signals S3 and the elementary color signals S4 corresponding to the same color light may also be transmitted to the same output buffer (for example, the output buffer 132) or other back-end circuit through the same output terminal OP1 by controlling the switch units 222.

### Third Embodiment

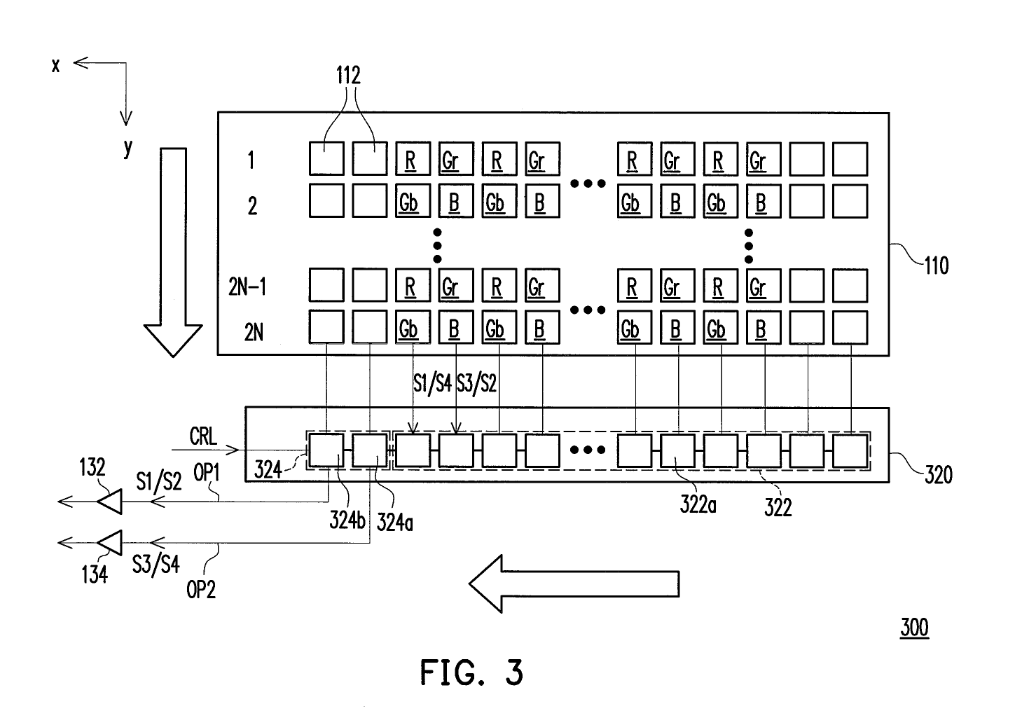

FIG. 3 is a diagram of an image sensing device 300 according to the third embodiment of the invention. The image sensing device 300 in the present embodiment is similar to the image sensing device 100 illustrated in FIG. 1, and the difference between the two image sensing devices falls between the shifting module 320 and the shifting module 120 in FIG. 1.

Referring to FIG. 3, in the present embodiment, the shifting module 320 includes a shifting unit 322 and a shifting unit 324. The shifting unit 322 includes a plurality of shift registers 322a. The shift registers 322a respectively receive the elementary color signals S1 generated by the pixel sensing units R and the elementary color signals S3 generated by the pixel sensing units Gr in the (2i−1)^{th} row. The shift registers 322a are connected in series and sequentially shift the elementary color signals S1 and the elementary color signals S3.

The shifting unit 324 is coupled to the shifting unit 322, and which receives one of the elementary color signals S1 or one of the elementary color signals S3. The shifting unit 324 outputs the received elementary color signal S1 and elementary color signal S3 respectively at the output terminal OP1 and the output terminal OP2 of the shifting module 320 according to a control signal CRL.

On the other hand, the shift registers 322a respectively receive the elementary color signals S4 generated by the pixel sensing units Gb and the elementary color signals S2 generated by the pixel sensing units B in the (2i)^{th} row and sequentially shift the elementary color signals S4 and the elementary color signals S2, so that the shifting unit 324 receives one of the elementary color signals S4 or one of the elementary color signals S2 from the shifting unit 322. The shifting unit 324 outputs the received elementary color signal S4 at the output terminal OP2 of the shifting module 320 or outputs the received elementary color signal S2 and elementary color signal S4 respectively at the output terminal OP1 and the output terminal OP2 of the shifting module 320 according to the control signal CRL.

To be specific, the shifting unit 324 includes two shift registers 324a and 324b that are connected with each other in series. The shift registers 324b and 324a respectively output the elementary color signals S1 and S3 according to the control signal CRL at a first time. For example, when the shift registers 324b and 324a respectively receive an elementary color signal S1 and an elementary color signal S3, the shifting unit 324 outputs the received elementary color signal S1 and elementary color signal S3 respectively at the output terminal OP1 and the output terminal OP2 of the shifting module 320 according to the control signal CRL.

In addition, the shifting unit 324 also reset the shift register 324b and outputs the elementary color signal S4 at the output terminal OP2 according to the control signal CRL at a second time, and the shifting unit 324 outputs the elementary color signal S3 and the elementary color signal S4 respectively at the output terminal OP1 and the output terminal OP2 at a third time. In the present embodiment, the shifting unit 324 outputs the elementary color signal S4 through the shift register 324a at the third time.

To be specific, when the shift register 324a receives the elementary color signals S4 generated by the pixel sensing units Gb in the same row for the first time, the shifting unit 324 resets the shift register 324b according to the control signal CRL and outputs the elementary color signal S4 at the output terminal OP2 at the second time. Then, when next time the shift registers 324b and 324a respectively receive the elementary color signal S2 and the elementary color signal S4, the shifting unit 324 outputs the received elementary color signal S2 and elementary color signal S4 respectively at the output terminal OP1 and the output terminal OP2 of the shifting module 320 according to the control signal CRL at the third time.

In other words, in the present embodiment, the shifting module 220 transmits the elementary color signals S3 and the elementary color signals S4 corresponding to the same color light to the same output buffer (for example, the output buffer 134) or other back-end circuit through the same output terminal OP2 through timing control, so that image noises caused by gain mismatch can be effectively eliminated.

Moreover, in another embodiment, the shifting module 320 may also output the elementary color signals S3 and S4 corresponding to the same color light at the output terminal OP1. For example, when the shift registers 324b and 324a respectively receive an elementary color signal S4 and an elementary color signal S2, the shifting unit 324 outputs the received elementary color signal S4 and elementary color signal S2 respectively at the output terminal OP1 and the output terminal OP2 of the shifting module 320 according to the control signal CRL at the first time.

Additionally, when the shift register 324a receives the elementary color signals S1 generated by the pixel sensing units R in the same row for the first time, the shifting unit 324 may also reset the shift register 324b according to the control signal CRL and output the elementary color signal S1 at the output terminal OP1 at the second time. Then, when next time the shift registers 324b and 324a respectively receive an elementary color signal S3 and an elementary color signal S1, the shifting unit 324 outputs the received elementary color signal S3 and elementary color signal S1 respectively at the output terminal OP1 and the output terminal OP2 of the shifting module 320 according to the control signal CRL at the third time. Accordingly, the shifting module 320 can output the elementary color signals S3 and S4 corresponding to the same color light at the output terminal OP1 through timing control.

### Fourth Embodiment

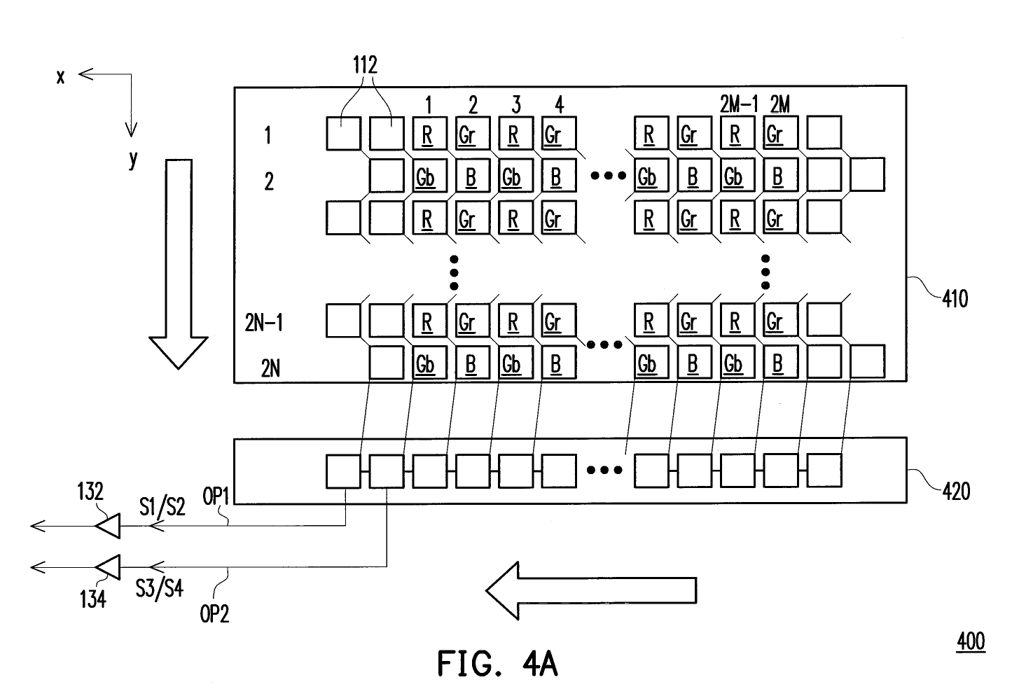

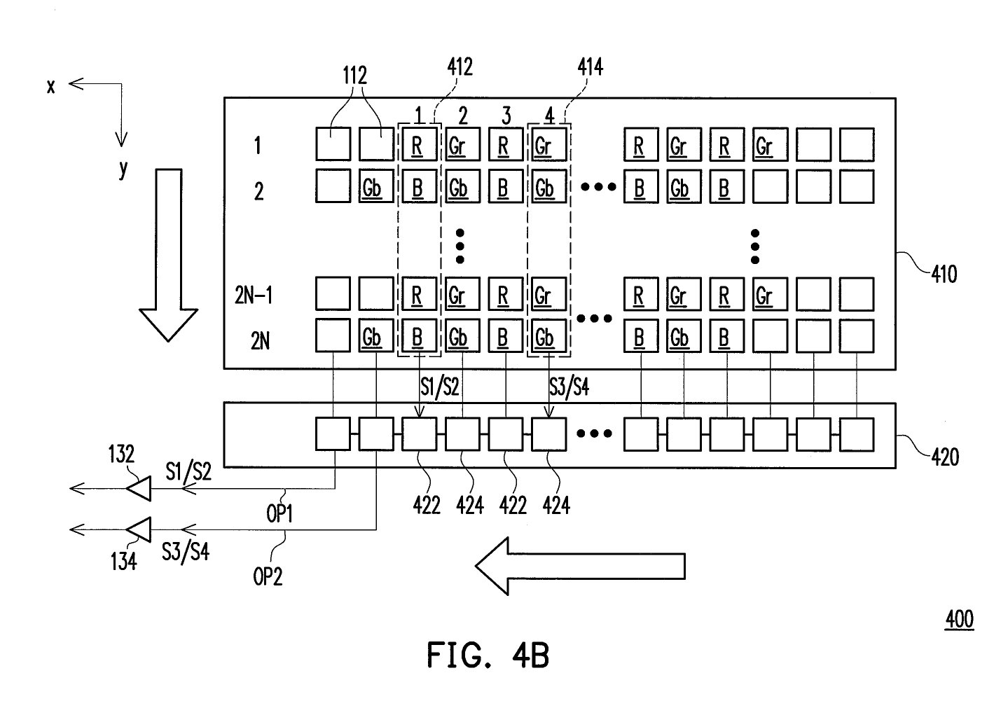

FIG. 4A is a diagram of an image sensing device 400 according to the fourth embodiment of the invention, and FIG. 4B is a simplified circuit diagram of the image sensing device 400 in FIG. 4A. The image sensing device 400 in the present embodiment is similar to the image sensing device 100 illustrated in FIG. 1, and the difference between the two image sensing devices falls on the circuit connections between the pixel sensing units R, B, Gr, and Gb.

To be specific, in the present embodiment, the pixel sensing units B in the (2i)^{th} row are respectively coupled to the pixel sensing units R in the (2i−1)^{th} row and the pixel sensing units R in the (2i+1)^{th} row and form a plurality of sensing strings 412 as shown in FIG. 4B. In addition, as shown in FIG. 4A, the pixel sensing units R coupled to the pixel sensing units B in the (2i)^{th} row are in the same column. For example, the pixel sensing unit B in the 2^{nd} row and the 4^{th} column is respectively coupled to the pixel sensing unit R in the 1^{st} row and the 3^{rd} column and the pixel sensing unit R in the 3^{rd} row and the 3^{rd} column.

Additionally, the pixel sensing units Gb in the (2i)^{th} row are respectively coupled to the pixel sensing units Gr in the (2i−1)^{th} row and the pixel sensing units Gr in the (2i+1)^{th} row and form a plurality of sensing strings 414 as shown in FIG. 4B. Moreover, as shown in FIG. 4A, the pixel sensing units Gb coupled to the pixel sensing units Gb in the (2i)^{th} row are in the same column. For example, the pixel sensing unit Gb in the 2^{nd} row and the 3^{rd} column is respectively coupled to the pixel sensing unit Gr in the 1^{st} row and the 2^{nd} column and the pixel sensing unit Gr in the 3^{rd} row and the 2^{nd} column.

Referring to FIG. 4B, in the present embodiment, the shifting module 420 includes a plurality of shift registers 422 and a plurality of shift registers 424. The shift registers 422 are respectively coupled to the sensing strings 412 for receiving the elementary color signals S1 generated by the pixel sensing units R. The shift registers 422 are respectively coupled to the sensing strings 414 for receiving the elementary color signals S3 generated by the pixel sensing units Gr. The shift registers 422 and the shift registers 424 are alternatively connected in series and sequentially shift the elementary color signals S1 and S3 so that the shifting module 420 outputs the elementary color signals S1 and the elementary color signals S3 respectively at the output terminal OP1 and the output terminal OP2.

On the other hand, the shift registers 422 further receive the elementary color signals S2 generated by the pixel sensing units Gr, and the shift registers 424 further receive the elementary color signals S4 generated by the pixel sensing units Gb. The shift registers 422 and 424 sequentially shift the elementary color signals S2 and S4 so that the shifting module 420 outputs the elementary color signals S2 and the elementary color signals S4 respectively as the output terminal OP1 and the output terminal. OP2.

As described above, in the present embodiment, the elementary color signals S3 and the elementary color signals S4 corresponding to the same color light are transmitted to the same output buffer (for example, the output buffer 134) or other back-end circuit through the same output terminal OP2 by changing the circuit connections between the pixel sensing units R, B, Gr, and Gb of the image sensing device 400, so that image noises caused by gain mismatch can be effectively eliminated. It should be noted that in other embodiments, the elementary color signals S3 and the elementary color signals S4 corresponding to the same color light may also be transmitted to the same output buffer (for example, the output buffer 132) or other back-end circuit through the same output terminal OP1 by changing the circuit connections between the pixel sensing units R, B, Gr, and Gb.

In summary, in an embodiment of the invention, two signals corresponding to the same color light are output through the same output terminal by adopting a shifting module, so that image noise caused by gain mismatch can be eliminated in back-end circuit.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image sensing device, comprising:
a light sensing plane, wherein a plurality of pixel blocks is disposed on the light sensing plane as an array, each of the pixel blocks generates a first elementary color signal, a second elementary color signal, a third elementary color signal, and a fourth elementary color signal according to an illumination intensity; and
a shifting module, having a first output terminal and a second output terminal, the shifting module receiving the first elementary color signals, the second elementary color signals, the third elementary color signals, and the fourth elementary color signals and outputting one of the third elementary color signals and one of the fourth elementary color signals at the second output terminal, wherein each of the third elementary color signals and each of the fourth elementary color signals are two signals corresponding to a same color light.

2. The image sensing device according to claim 1, wherein the shifting module further outputs one of the first elementary color signals and one of the second elementary color signals at the first output terminal.

3. The image sensing device according to claim 1, wherein each of the pixel blocks comprises a first pixel sensing unit, a second pixel sensing unit, a third pixel sensing unit, and a fourth pixel sensing unit to respectively generate the corresponding first elementary color signal, the corresponding second elementary color signal, the corresponding third elementary color signal, and the corresponding fourth elementary color signal.

4. The image sensing device according to claim 2, wherein the first pixel sensing units and the third pixel sensing units are alternatively disposed in a (2i−1)^{th} row of the light sensing plane, and the second pixel sensing units and the fourth pixel sensing units are alternatively disposed in a (2i)^{th} row of the light sensing plane, wherein the third pixel sensing units in the (2i−1)^{th} row and the fourth pixel sensing units in the (2i)^{th} row are disposed in different columns, 1≦2i≦2N, and i and N are positive integers greater than or equal to 1.

5. The image sensing device according to claim 4, wherein the shifting module comprises:
a plurality of shift registers, respectively and correspondingly receiving the first elementary color signals and the third elementary color signals in the (2i−1)^{th} row, wherein the shift registers are connected in series and sequentially shift the first elementary color signals and the third elementary color signals to output one of the first elementary color signals and one of the third elementary color signals; and
a switch unit, coupled to the shift registers, receiving the corresponding first elementary color signal and the corresponding third elementary color signal and outputting the received first elementary color signal and the received third elementary color signal respectively at the first output terminal and the second output terminal of the shifting module.

6. The image sensing device according to claim 5, wherein the shift registers further respectively and correspondingly receive the fourth elementary color signals and the second elementary color signals in the (2i)^{th} row, the shift registers sequentially shift the fourth elementary color signals and the second elementary color signals and output one of the fourth elementary color signals and one of the second elementary color signals, and the switch unit receives the corresponding fourth elementary color signal and the corresponding second elementary color signal and outputs the received second elementary color signal and the received fourth elementary color signal respectively at the first output terminal and the second output terminal of the shifting module.

7. The image sensing device according to claim 4, wherein the shifting module comprises:
a plurality of switch units, wherein each of the switch units has a first input terminal, a second input terminal, a third output terminal, and a fourth output terminal, the first input terminals receive the first elementary color signals in the (2i−1)^{th} row and output the first elementary color signals at the third output terminals, and the second input terminals receive the third elementary color signals in the (2i−1)^{th} row and output the third elementary color signals at the fourth output terminals; and
a plurality of shift registers, wherein each of the shift registers is correspondingly coupled to one of the third output terminals or one of the fourth output terminals, and the shift registers are connected in series and sequentially shift the first elementary color signals and the third elementary color signals to output one of the first elementary color signals and one of the third elementary color signals respectively at the first output terminal and the second output terminal of the shifting module.

8. The image sensing device according to claim 7, wherein the first input terminals further receive the fourth elementary color signals in the (2i)^{th} row and output the fourth elementary color signals at the fourth output terminals, the second input terminals further receive the second elementary color signals in the (2i)^{th} row and output the second elementary color signals at the third output terminals, the shift registers sequentially shift the second elementary color signals and the fourth elementary color signals to output one of the second elementary color signals and one of the fourth elementary color signals respectively at the first output terminal and the second output terminal of the shifting module.

9. The image sensing device according to claim 4, wherein the shifting module comprises:
a first shifting unit, comprising a plurality of first shift registers, respectively and correspondingly receiving the first elementary color signals and the third elementary color signals in the (2i−1)^{th} row, wherein the first shift registers are connected in series and sequentially shift the first elementary color signals and the third elementary color signals; and
a second shifting unit, coupled to the first shifting unit, receiving one of the first elementary color signals or one of the third elementary color signals and outputting the received first elementary color signal and the received third elementary color signal respectively at the first output terminal and the second output terminal of the shifting module according to a control signal.

10. The image sensing device according to claim 9, wherein the first shift registers further respectively and correspondingly receive the fourth elementary color signals and the second elementary color signals in the (2i)^{th} row and sequentially shift the fourth elementary color signals and the second elementary color signals; and
the second shifting unit further receives one of the fourth elementary color signals or one of the second elementary color signals and outputs the received fourth elementary color signal at the second output terminal of the shifting module or outputs the received second elementary color signal and the received fourth elementary color signal respectively at the first output terminal and the second output terminal of the shifting module according to the control signal.

11. The image sensing device according to claim 10, wherein the second shifting unit comprises two second shift registers that are connected in series, and the second shift registers respectively output the first elementary color signal and the third elementary color signal according to the control signal at a first time.

12. The image sensing device according to claim 11, wherein the second shifting unit resets one of the second shift registers and outputs the fourth elementary color signal at the second output terminal of the shifting module according to the control signal at a second time, and the second shifting unit outputs the fourth elementary color signal and the second elementary color signal respectively at the first output terminal and the second output terminal of the shifting module at a third time.

13. The image sensing device according to claim 12, wherein the second shifting unit outputs the fourth elementary color signal at the third time through another one of the second shift registers.

14. The image sensing device according to claim 4, wherein the second pixel sensing units in the (2i)^{th} row are respectively coupled to the first pixel sensing units in the (2i−1)^{th} row and the first pixel sensing units in a (2i+1)^{th} row and form a plurality of first sensing strings.

15. The image sensing device according to claim 14, wherein the first pixel sensing units coupled to the first pixel sensing units in the (2i)^{th} row are in a same column.

16. The image sensing device according to claim 14, wherein the fourth pixel sensing units in the (2i)^{th} row are respectively coupled to the third pixel sensing units in the (2i−1)^{th} row and the third pixel sensing units in the (2i+1)^{th} row and form a plurality of second sensing strings.

17. The image sensing device according to claim 16, wherein the third pixel sensing units coupled to the fourth pixel sensing units in the (2i)^{th} row are in a same column.

18. The image sensing device according to claim 16, wherein the shifting module comprises:
a plurality of first shift registers, respectively coupled to the first sensing strings to receive one of the first elementary color signals; and
a plurality of second shift registers, respectively coupled to the second sensing strings to receive one of the third elementary color signals, wherein the first shift registers and the second shift registers are alternatively connected in series and sequentially shift the first elementary color signals and the third elementary color signals so that the shifting module outputs one of the first elementary color signals and one of the third elementary color signals respectively at the first output terminal and the second output terminal.

19. The image sensing device according to claim 18, wherein the first shift registers further receive one of the second elementary color signals, the second shift registers further receive one of the fourth elementary color signals, the first shift registers and the second shift registers sequentially shift the second elementary color signals and the fourth elementary color signals so that the shifting module outputs one of the second elementary color signals and one of the fourth elementary color signals respectively at the first output terminal and the second output terminal.

20. The image sensing device according to claim 1, wherein each of the first elementary color signals and each of the second elementary color signals are two signals corresponding to different color lights.
